(19) United States
(12) Patent Application Publication
(10) Pub. No.: US 2025/0128924 A1
(43) Pub. Date: Apr. 24, 2025

(54) MODEL-BASED AUTONOMOUS MOBILE ROBOT OPERATIONS ON PIECEWISE FLAT FLOORS

(71) Applicant: Gideon Brothers d.o.o., Osijek (HR)

(72) Inventors: Darko Janekovic, Zagreb (HR); Juraj Radic, Stupnik (HR); Josip Cesic, Zagreb (HR); Kruno Lenac, Zagreb (HR); Tonci Novkovic, Zagreb (HR)

(21) Appl. No.: 18/919,034

(22) Filed: Oct. 17, 2024

Related U.S. Application Data
(60) Provisional application No. 63/591,388, filed on Oct. 18, 2023.

(51) Int. Cl. B66F 9/06; B66F 9/24

(52) U.S. Cl. CPC B66F 9/063; B66F 9/24

(57) ABSTRACT

A method implemented at an autonomous mobile robot equipped with a fork to carry a pallet. The robot transitions between a first and second piecewise flat floor segments with differing geometries. The robot uses sensor data from sensors such as LIDAR, stereo cameras, GPS, and ultrasound sensors to determine the transition between the first and second piecewise flat floor segments. The fork operates based on parameters that meet reference constraints. When the robot detects that a second floor geometry would cause these parameters to no longer meet the reference constraints, the robot determines new parameters that will satisfy the reference constraints. Control signals are then sent to adjust the fork's operation as the robot transitions to the second floor segment.

### CROSS-REFERENCE TO RELATED APPLICATION

This application claims the benefit of U.S. Provisional Patent Application No. 63/591,388, filed Oct. 18, 2023, which is incorporated by reference in its entirety.

### BACKGROUND

An autonomous mobile robot, such as an autonomous forklift, is a robot that is capable of autonomously navigating an environment (e.g., a warehouse environment) and manipulating objects within that environment. An autonomous mobile robot may use a 2D environment map to navigate within a warehouse environment. The environment map may include information about objects and obstacles within the warehouse. For example, the environment map may contain information about the poses of objects within the warehouse, and the autonomous mobile robot may use that information when manipulating the objects within the warehouse.

Traditional autonomous mobile robots are designed for flat floors, where two-dimensional control of movement is sufficient to avoid collisions with walls or objects. However, in some cases, an autonomous mobile robot may need to operate on uneven or piecewise flat floors, such as those found in trailer loading/unloading areas or certain warehouse sections. In such environments with transitions between floor segments at different angles (e.g., ramps or trailer floors), these autonomous mobile robots risk either hitting the floor with the forks or the load hitting the ceiling especially when the floor and ceiling height geometry varies.

### SUMMARY

Embodiments described herein address the above-described challenge by enabling an autonomous mobile robot to dynamically adjust lift and/or tilt of forks based on a model of an environment or real-time sensor feedback.

In some embodiments, it is determined that an autonomous mobile robot transitions from a first piecewise flat floor segment having a first geometry to a second piecewise flat floor segment having a second geometry based on sensing data generated by one or more sensors integrated with the fork. The fork is set to operation parameters that meet reference constraints. The sensors includes one or more of a light detection and ranging (LIDAR) sensor, stereo camera, 2D camera, 3D camera, ultrasound sensor, inertial measurement unit, global positioning system (GPS), and/or time-of-flight camera.

The autonomous mobile robot determines that the second geometry would cause the operation parameters to no longer satisfy the reference constraints, and determines new operation parameters based on the second geometry that satisfy the reference constraints, and transmits one or more control signals to the fork to transition using the new operation parameters when the autonomous mobile robot enters the second piecewise flat floor segment. In some embodiments, the reference constraints include one or more of: a minimum distance between the fork and a floor and a maximum tilt angle of the fork. The operation parameters include one or more of: a height of the fork and a tilt angle of the fork.

In some embodiments, the robot picks up a pallet with a load (referred to simply as a pallet), determines a geometry of the pallet, and determines the new operation parameters further based on the geometry of the pallet. For example, the robot may adjust the operation parameters to cause that the pallet carried by the fork maintains clearance from an overhead obstacle while transitioning between the first piecewise flat floor segment and the second piecewise flat floor segment.

In some embodiments, the robot operates at any given time in a model-based mode or a close-loop mode. In the model-based mode, the robot navigates based on model data describing piecewise flat floor segments. In closed-loop mode, the robot navigates based on sensing data generated by the one or more sensors. The robot automatically switches between the model-based mode and the closed-loop mode in response to determinations as to whether model data of a piecewise flat floor segment is available.

### BRIEF DESCRIPTION OF THE DRAWINGS

FIG. 1 illustrates an environment for operating an autonomous mobile robot using a central communication system, in accordance with some embodiments.

FIG. 2 illustrates exemplary modules and data stores used by a central communication system, in accordance with some embodiments.

FIG. 3 illustrates exemplary modules and data stores used by the autonomous mobile robot, in accordance with some embodiments.

FIG. 4 illustrates an example autonomous mobile robot navigating through a warehouse environment to a trailer, in accordance with some embodiments.

FIG. 5A illustrates example characteristics that the autonomous mobile robot may determine based on sensor data, in accordance with some embodiments.

FIG. 5B illustrates example locations of the autonomous mobile robot and objects within the trailer, as determined by the autonomous mobile robot, in accordance with some embodiments.

FIG. 6A illustrates an autonomous mobile robot approaching a ramp that leads from the warehouse to the trailer, in accordance with some embodiments.

FIG. 6B illustrates an autonomous mobile robot attempting to unload an object in the last row of the trailer without adjusting its forklift, in accordance with some embodiments.

FIG. 6C illustrates an autonomous mobile robot that adjusts its forklift to be level with the floor of the trailer, in accordance with some embodiments.

FIG. 7 illustrates an example autonomous mobile robot that uses a centerline heuristic to navigate within a trailer, in accordance with some embodiments.

FIG. 8 illustrates an example environment in which a floor includes multiple piecewise flat segments, in accordance with some embodiments.

FIG. 9 illustrates an example environment in which an autonomous mobile robot interacts with a pallet in an environment with multiple piecewise segments, in accordance with some embodiments.

FIG. 10 illustrates an example environment, in which an autonomous mobile robot operates in a closed-loop mode, in accordance with some embodiments.

FIG. 11 illustrates an example environment, in which an autonomous mobile robot adjusts lift and tilt of forks to align the forks with a pallet, in accordance with some embodiments.

FIG. 12 is a flowchart of an example method for navigating an autonomous mobile robot across multiple piecewise flat floor segments in a model-based mode, in accordance with some embodiments.

FIG. 13 is a flowchart of an example method for navigating an autonomous mobile robot across multiple piecewise flat floor segments in a closed-loop mode, in accordance with some embodiments.

### DETAILED DESCRIPTION

Autonomous mobile robots may be used for load handling tasks. To perform load handling, these autonomous mobile robots are equipped with load handling mechanisms. For instance, some autonomous mobile robots may include load handling systems like forks, which are used to lift, carry, and transport loads such as pallets, crates, or containers. Traditionally, these robots are typically designed to operate on flat floors, where two-dimensional movement control is sufficient to prevent collisions with walls or obstacles. However, in environments with transitions between floor segments at varying angles (e.g., ramps or trailer floors), these robots face the risk of the load handling mechanism hitting the floor or the load striking the ceiling, particularly when the floor geometry and ceiling height vary.

The embodiments described herein address the above described challenge by implanting systems and methods that enable the autonomous mobile robots to dynamically adjust lift and tilt of their forks based on a model of the environment or real-time sensor feedback. The model may be created from either user inputs or sensor data to capture the geometry of the floor. Based on the model and/or the sensor data, the autonomous mobile robots can predict and adjust their fork positions to minimize computational burden and improve battery life.

In some embodiments, when a model is not available or incomplete, the autonomous mobile robots can operate in a closed-loop mode, using onboard sensors to continuously monitor the fork's position and adjust in real time. In some embodiments, the autonomous mobile robots can toggle between a model-based mode and a closed-loop mode based on availability of model. This flexibility ensures that the autonomous mobile robot can navigate complex environments safely without requiring excessive computational power or risking damage to the load or the robot.

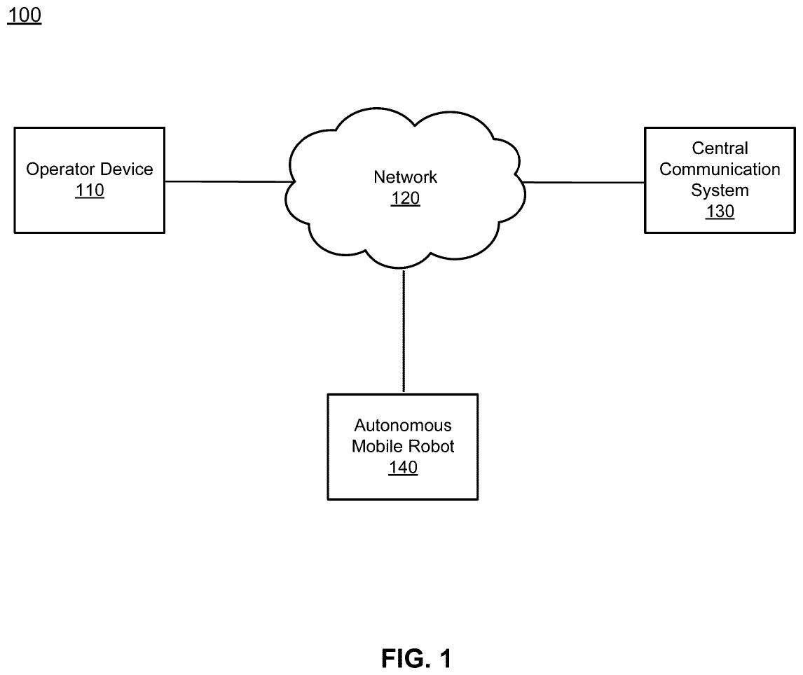

Additional details about the autonomous mobile robots are further described below with respect to FIGS. 1-13.

### System Environment

Figure (FIG. 1 illustrates an environment for operating an autonomous mobile robot using a central communication system, in accordance with some embodiments. Environment 100 includes operator device 110, network 120, central communication system 130, and autonomous mobile robot 140. Environment 100 may be generally described herein as a warehouse environment, however, environment 100 may be any kind of environment. Environment 100 need not be limited to a defined space (e.g., an interior of a warehouse), and may include any areas that are within the purview of instructions of an autonomous mobile robot (e.g., parking lots, loading docks, and so on that are outside of a warehouse space). While operator device 110 and central communication system 130 are depicted as being within environment 100, this is merely for convenience; these devices may be located outside of environment 100 (e.g., at a home, office, data center, cloud environment, etc.). Additional embodiments may include more, fewer, or different components from those illustrated in FIG. 1, and the functionality of each component may be divided between the components differently from the description below. Additionally, each component may perform their respective functionalities in response to a request from a human, or automatically without human intervention.

Operator device 110 may be any client device that interfaces one or more human operators with one or more autonomous mobile robots of environment 100 and/or central communication system 130. Exemplary client devices include smartphones, tablets, personal computers, kiosks, and so on. While only one operator device 110 is depicted, this is merely for convenience, and a human operator may use any number of operator devices to interface with autonomous mobile robots 140 or the central communication system 130. Operator device 110 may have a dedicated application installed thereon (e.g., downloaded from central communication system 130) for interfacing with the autonomous mobile robot 140 or the central communication system 130. Alternatively, or additionally, operator device 110 may access such an application by way of a browser. References to operator device 110 in the singular are done for convenience only, and equally apply to a plurality of operator devices.

Network 120 may be any network suitable for connecting operator device 110 with central communication system 130 and/or autonomous mobile robot 140. Exemplary networks may include a local area network, a wide area network, the Internet, an ad hoc network, and so on. In some embodiments, network 120 may be a closed network that is not connected to the Internet (e.g., to heighten security and prevent external parties from interacting with central communication system 130 and/or autonomous mobile robot 140). Such embodiments may be particularly advantageous where client device 110 is within the boundaries of environment 100.

Central communication system 130 acts as a central controller for a fleet of one or more robots including autonomous mobile robot 140. Central communication system 130 receives information from the fleet or the operator device 110 and uses that information to make decisions about activity to be performed by the fleet. Central communication system 130 may be installed on one device, or may be distributed across multiple devices. Central communication system 130 may be located within environment 100 or may be located outside of environment 100 (e.g., in a cloud implementation).

Autonomous mobile robot 140 may be any robot configured to act autonomously with respect to a command. For example, an autonomous mobile robot 140 may be commanded to move an object from a source area to a destination area, and may be configured to make decisions autonomously as to how to optimally perform this function (e.g., which side to lift the object from, which path to take, and so on). Autonomous mobile robot 140 may be any robot suitable for performing a commanded function. Exemplary autonomous mobile robots include vehicles, such as forklifts, mobile storage containers, etc. References to autonomous mobile robot 140 in the singular are made for convenience and are non-limiting; these references equally apply to scenarios including multiple autonomous mobile robots.

### Exemplary Central Communication System Configuration

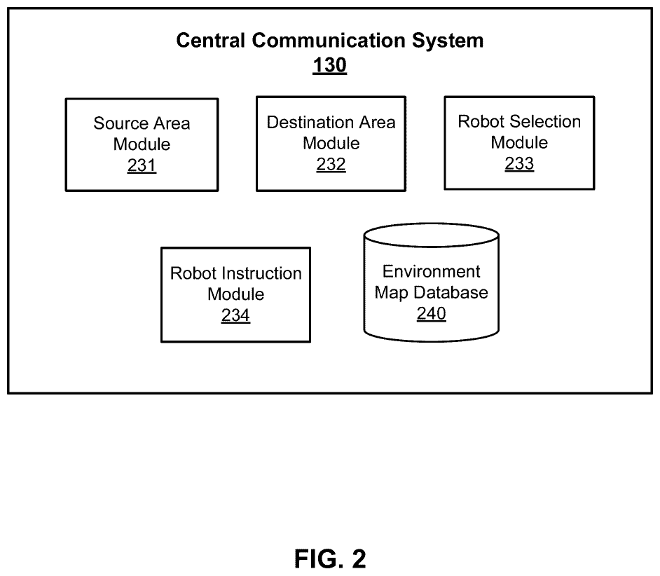

FIG. 2 illustrates exemplary modules and data stores used by the central communication system 130, in accordance with some embodiments. The central communication system 130 may include a source area module 231, a destination area module 232, a robot selection module 233, and a robot instruction module 234, as well as an environment map database 240. The modules and databases depicted in FIG. 2 are merely exemplary; fewer or more modules and/or databases may be used by central communication system 130 to achieve the functionality disclosed herein. Additionally, the functionality of each component may be divided between the components differently from the description below. Additionally, each component may perform their respective functionalities in response to a request from a human, or automatically without human intervention.

The source area module 231 identifies a source area. The term source area, as used herein, may refer to either a single point, several points, or a region surrounded by a boundary (sometimes referred to herein as a source boundary) within which a robot is to manipulate objects (e.g., pick up objects for transfer to another area). In an embodiment, the source area module 231 receives input from operator device 110 that defines the point(s) and/or region that form the source area. In an embodiment, the source area module 231 may receive input from one or more robots (e.g., image and/or depth sensor information showing objects known to need to be moved (e.g., within a predefined load dock)), and may automatically determine a source area to include a region within a boundary that surrounds the detected objects. The source area may change dynamically as objects are manipulated (e.g., the source area module 232 may shrink the size of the source area by moving boundaries inward as objects are transported out of the source area, and/or may increase the size of the source area by moving boundaries outward as new objects are detected).

The destination area module 232 identifies a destination area. The term destination area, as used herein, may refer to either a single point, several points, or a region surrounded by a boundary (sometimes referred to herein as a destination boundary) within which a robot is to manipulate objects (e.g., drop an object off to rest). For example, where the objects are pallets in a warehouse setting, the destination area may include several pallet stands at different points in the facility, any of which may be used to drop off a pallet. The destination area module 232 may identify the destination area in any manner described above with respect to a source area, and may also identify the destination area using additional means.

The destination area module 232 may determine the destination area based on information about the source area and/or the objects to be transported. Objects in the source area may have certain associated rules that add constraints to the destination area. For example, there may be a requirement that the objects be placed in a space having a predefined property (e.g., a pallet must be placed on a pallet stand, and thus the destination area must have a pallet stand for each pallet to be moved). As another example, there may be a requirement that the objects be placed at least a threshold distance away from the destination area boundary, and thus, destination area module 232 may require a human draw the boundary at least at this distance and/or may populate the destination boundary automatically according to this rule (and thus, the boundary must be drawn at least that distance away). Yet further, destination area module 232 may require that the volume of the destination area is at least large enough to accommodate all of the objects to be transported that are initially within the source area.

Source area module 231 and destination area module 232 may, in addition to, or alternative to, using rules to determine their respective boundaries, may use machine learning models to determine their respective boundaries. The models may be trained to take information as input, such as some or all of the above-mentioned constraints, sensory data, map data, object detection data, and so on, and to output boundaries based thereon. The models may be trained using data on tasks assigned to robots in the past, such as data on how operators have defined or refined the tasks based on various parameters and constraints.

Robot selection module 233 selects one or more robots that are to transport objects from the source area to the destination area. In an embodiment, robot selection module 233 performs this selection based on one or more of a manipulation capability of the robots and a location of the robots within the facility. The term manipulation capability, as used herein, refers to a robot's ability to perform a task related to manipulation of an object. For example, if an object must be lifted, the robot must have the manipulation capability to lift objects, to lift an object having at least the weight of the given object to be lifted, and so on. Other manipulation capabilities may include an ability to push an object, an ability to drive an object (e.g., a mechanical arm may have an ability to lift an object, but may be unable to drive an object because it is affixed to, e.g., the ground), and so on. Further manipulation capabilities may include lifting and then transporting objects, hooking and then towing objects, tunneling and then transporting objects, using robots in combination with one another (e.g., an arm or other manipulates an object (e.g., lifts), places on another robot, and the robot then drives to the destination with the object). These examples are merely exemplary and non-exhaustive. Robot selection module 233 may determine required manipulation capabilities to manipulate the object(s) at issue, and may select one or more robots that satisfy those manipulation capabilities.

In terms of location, robot selection module 233 may select one or more robots based on their location to the source area and/or the destination area. For example, robot selection module 233 may determine one or more robots that are closest to the source area, and may select those robot(s) to manipulate the object(s) in the source area. Robot selection module 233 may select the robot(s) based on additional factors, such as a number of objects to be manipulated, manipulation capabilities of the robot (e.g., how many objects can the robot carry at once; sensors the robot is equipped with; etc.), motion capabilities of the robot, and so on. In an embodiment, robot selection module 233 may select robots based on a state of one or more robot's battery (e.g., a closer robot may be passed up for a further robot because the closer robot has insufficient battery to complete the task). In an embodiment, robot selection module 233 may select robots based on their internal health status (e.g., where a robot is reporting an internal temperature close to overheating, that robot may be passed up even if it otherwise optimal, to allow that robot to cool down). Other internal health status parameters may include battery or fuel levels, maintenance status, and so on. Yet further factors may include future orders, a scheduling strategy that incorporates a longer horizon window (e.g., a robot that is optimal to be used now may, if used now, result in inefficiencies (e.g., depleted battery level or sub-optimal location), given a future task for that robot), a scheduling strategy that incorporates external processes, a scheduling strategy that results from information exchanged between higher level systems (e.g., WMS, ERP, EMS, etc.), and so on.

The robot selection module 233 may select a robot using machine learning model trained to take various parameters as input, and to output one or more robots best suited to the task. The inputs may include available robots, their manipulation capabilities, their locations, their state of health, their availability, task parameters, scheduling parameters, map information, and/or any other mentioned attributes of robots and/or tasks. The outputs may include an identification of one or more robots to be used (or suitable to be used) to execute a task. The robot selection module 233 may automatically select one or more of the identified robots for executing a task, or may prompt a user of operator device 110 to select from the identified one or more robots.

The robot instruction module 234 transmits instructions to the selected one or more robots to manipulate the object(s) in the source area (e.g., to ultimately transport the object(s) to the destination area). In an embodiment, the robot instruction module 234 includes detailed step-by-step instructions on how to transport the objects. In another embodiment, the robot instruction module 234 transmits a general instruction to transmit one or more objects from the source area to the destination area, leaving the manner in which the objects will be manipulated and ultimately transmitted up to the robot to determine autonomously.

The robot instruction module 234 may transmit instructions to a robot to traverse from a start pose to an end pose. In some embodiments, the robot instruction module 234 simply transmits a start pose and end pose to the robot and the robot determines a path from the start pose to the end pose. Alternatively, the robot instruction module 234 may provide some information on a path the robot should take to travel from the start pose to the end pose. Robot pathfinding is discussed in more detail below.

Environment map database 240 stores information about the environment of the autonomous mobile robot 140. The environment of an autonomous mobile robot 140 is the area within which the autonomous mobile robot 140 operates. For example, the environment may be a facility or a parking lot within which the autonomous mobile robot 140 operates. In some embodiments, the environment map database 240 stores environment information in one or more maps representative of the environment. The maps may be two-dimensional, three dimensional, or a combination of both. Central communication system 130 may receive a map from operator device 110, or may generate one based on input received from one or more robots 140 (e.g., by stitching together images and/or depth information received from the robots as they traverse the facility, and optionally stitching in semantic, instance, and/or other sensor-derived information into corresponding portions of the map). In some embodiments, the map stored by the environment map database 240 indicates the locations of obstacles within the environment. The map may include information about each obstacle, such as whether the obstacle is an animate or inanimate object.

Environment map database 240 may be updated by central communication system 130 based on information received from the operator device 110 or from the robots 140. Information may include images, depth information, auxiliary information, semantic information, instance information, and any other information described herein. The environment information may include information about objects within the facility, obstacles within the facility, and auxiliary information describing activity in the facility. Auxiliary information may include traffic information (e.g., a rate at which humans and/or robots access a given path or area within the facility), information about the robots within the facility (e.g., manipulation capability, location, etc.), time-of-day information (e.g., traffic as it is expected during different segments of the day), and so on.

The central communication system 130 may continuously update environment information stored by the environment map database 240 as such information is received (e.g., to show a change in traffic patterns on a given path). The central communication system 130 may also update environment information responsive to input received from the operator device 110 (e.g., manually inputting an indication of a change in traffic pattern, an area where humans and/or robots are prohibited, an indication of a new obstacle, and so on).

### Exemplary Autonomous Mobile Robot Configuration

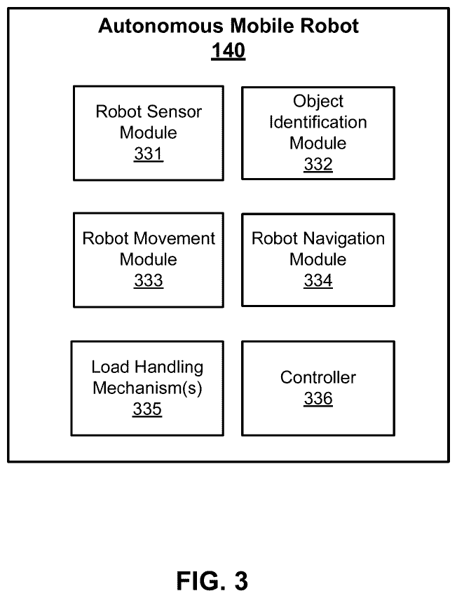

FIG. 3 illustrates exemplary modules and data stores used by the autonomous mobile robot, in accordance with some embodiments. As depicted in FIG. 3, autonomous mobile robot 140 includes a robot sensor module 331, an object identification module 332, a robot movement module 333, a robot navigation module 334, a load handling mechanism 335 and a controller 336. The modules and databases depicted in FIG. 3 are merely exemplary; fewer or more modules and/or databases may be used to achieve the functionality described herein. Furthermore, any of the described functionality of the modules may instead be performed by the central communication system 130 or the operator device 110. Additionally, any of the functionality of these modules may be performed with or without human instruction.

The robot sensor module 331 includes a number of sensors that the robot uses to collect data about the robot's surroundings. For example, the robot sensor module 331 may include one or more cameras, one or more depth sensors, one or more scan sensors (e.g., RFID), a location sensor (e.g., showing location of the robot within the facility and/or GPS coordinates), and so on. Additionally, the robot sensor module 331 may include software elements for preprocessing sensor data for use by the robot. For example, the robot sensor module 331 may generate depth data information based on LIDAR sensor data. Data collected by the robot sensor module 331 may be used by the object identification module 332 to identify obstacles around the robot or may be used to determine a pose into which the robot must travel to reach an end pose.

The object identification module 332 ingests information received from the robot sensor module 331, and outputs information that identifies an object in proximity to the robot. The object identification module 332 may utilize information from a map of the facility (e.g., as retrieved from environment map database 240) in addition to information from the robot sensor module 331 in identifying the object. For example, the object identification module 332 may utilize location information, semantic information, instance information, and so on to identify the object.

Additionally, the object identification module 332 identifies obstacles around the robot for the robot to avoid. For example, the object identification module 332 determines whether an obstacle is an inanimate obstacle (e.g., a box, a plant, or a column) or an animate object (e.g., a person or an animal). The object identification module 332 may use information from the environment map database 240 to determine where obstacles are within the robot's environment. Similarly, the object identification module 332 may use information from the robot sensor module 331 to identify obstacles around the robot.

The robot movement module 333 transports the robot within its environment. For example, the robot movement module 333 may include a motor, wheels, tracks, and/or legs for moving. The robot movement module 333 may include components that the robot uses to move from one pose to another pose. For example, the robot may use components in the robot movement module 333 to change its x-, y-, or z-coordinates or to change its orientation. In some embodiments, the robot movement module 333 receives instructions from the robot navigation module 334 to follow a path determined by the robot navigation module 334 and performs the necessary actions to transport the robot along the determined path.

The robot navigation module 334 determines a path for the robot from a start pose to an end pose within the environment. A pose of the robot may refer to an orientation of the robot and/or a location of the robot (including x-, y-, and z-coordinates). The start pose may be the robot's current pose or some other pose within the environment. The end pose may be an ultimate pose within the environment to which the robot is traveling or may be an intermediate pose between the ultimate pose and the start pose. The path may include a series of instructions for the robot to perform to reach the goal pose. For example, the path may include instructions for the robot to travel from one x-, y-, or z-coordinate to another and/or to adjust the robot's orientation (e.g., by taking a turn or by rotating in place). In some embodiments, the robot navigation module 334 implements routing instructions received by the robot from the central communication system 130. For example, the central communication system 130 may transmit an end pose to the robot navigation module 334 or a general path for the robot to take to a goal pose, and the robot navigation module 334 may determine a path that avoids objects, obstacles, or people within the environment. The robot navigation module 334 may determine a path for the robot based on sensor data or based on environment data. In some embodiments, the robot navigation module 334 updates an already determined path based on new data received by the robot.

In some embodiments, the robot navigation module 334 receives an end location and the robot navigation module 334 determines an orientation of the robot necessary to perform a task at the end location. For example, the robot may receive an end location and an instruction to deliver an object at the end location, and the robot navigation module 334 may determine an orientation that the robot must take to properly deliver the object at the end location. The robot navigation module 334 may determine a necessary orientation at the end location based on information captured by the robot sensor module 331, information stored by the environment map database 240, or based on instructions received from an operator device. In some embodiments, the robot navigation module 334 uses the end location and the determined orientation at the end location to determine the end pose for the robot.

The load handling mechanism 335 is configured to lift and carry loads. In some embodiments, the load handling mechanism includes a fork and a lift assembly configured to raise and lower the fork. In some embodiments, the load handling mechanism 335 is also capable of horizontal movements (e.g., forward, retract, or shift horizontally) and angular movements (e.g., tilt forward or backward).

The controller 336 is configured to control the load handling mechanism 335 of the autonomous mobile robot 140. For example, when picking up a load, the controller 336 lowers the load handling mechanism 335 and adjusts a tilt of the load handling mechanism 335 to align the load handling mechanism 335 with a load. For example, when the load handling mechanism 335 includes a fork, the controller 336 can moves the fork horizontally cause the fork to reach deeper into a pallet before lifting. After picking up the pallet, the controller may also horizontally move the fork by adjusting a distance between the fork and a body of the robot 140 to stabilize the pallet. The controller 336 may tilt the fork forward or backward to adjust the pallet's angle. For stability during transport, the fork may tilt slightly backward to prevent the pallet from sliding off.

For unloading or storage, the controller 336 aligns the pallet at the appropriate height and angle for placement. During unloading, the fork may be tilted forward to ensure a smooth release of the load at the designated drop-off point.

When navigating uneven or angled surfaces, such as ramps or piecewise flat floors, the controller 336 adjusts the tilt to compensate for environmental angles, ensuring safe and steady handling. When navigating without a pallet, the controller 336 adjusts the movement based on the pose of the fork and the geometry of the environment to avoid contact with any slopes. When navigating with a pallet, the controller 336 additionally takes into account the pose and dimensions of the pallet to prevent both the fork and the pallet from striking a slope or encountering overhead obstructions, such as the ceiling of a trailer.

In some embodiments, the controller 336 is configured to control the operation of the fork based on various operational parameters, such as its height, tilt, and/or horizontal position. The controller 336 may also be configured with one or more reference constraints, which can include a minimum distance between the fork and the floor, a maximum allowable tilt angle of the fork, a maximum allowable tilt angle of the robot 140's body, and/or a maximum angle difference between two interconnected piecewise flat segments. The controller 336 continuously adjusts the fork's operational parameters to ensure these reference constraints are met. For example, when the autonomous mobile robot 140 transitions from a flat surface to a sloped area, the operational parameters that were sufficient on the flat surface may no longer meet the reference constraints during the transition. In such cases, the controller 336 adjusts the operational parameters to maintain compliance with the reference constraints. In certain situations, if the maximum or minimum operational parameters are still unable to meet the reference constraints, the controller 336 may stop the operation and issue an alert.

Although the descriptions provided herein are primarily about a fork-based load handling system, the same principles are applicable to other load handling mechanisms. Whether using clamps, grippers, or other types of lifting and transporting equipment, the methods of side-shifting, precise positioning, and sensor-based contact detection described can be implemented in a similar manner. These techniques ensure efficient handling of loads regardless of the specific mechanism employed by the autonomous mobile robot. Moreover, while a pallet is used as an exemplary throughout the specification, any type of load may be manipulated by the load handling system including boxes, crates, and any other loads.

### Example Automated Trailer Loading and Unloading

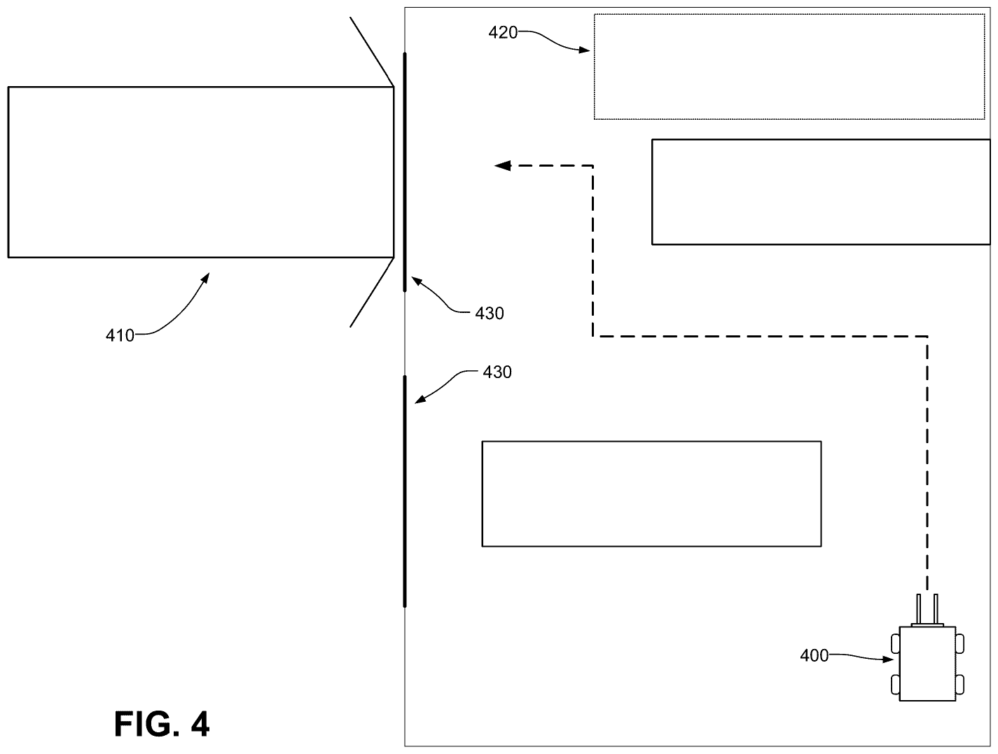

FIG. 4 illustrates an example autonomous mobile robot 400 navigating through a warehouse environment to a trailer 410, in accordance with some embodiments. The autonomous mobile robot 400 may have been instructed by a central communication system to load or unload the trailer 410. The central communication system also may have specified an area 420 to which autonomous mobile robot 400 may unload objects from the trailer 410 or from which the autonomous mobile robot 400 may obtain objects to load into the trailer 410. The central communication system may also specify which of a set docking points 430 the trailer 410 has docked to.

When the autonomous mobile robot reaches the docking point, the autonomous mobile robot may use sensor data to collect information about the trailer. The sensor data is data collected by one or more sensors on the autonomous mobile robot. For example, the sensor data may include LIDAR data captured by a LIDAR sensor and/or image data captured by a camera. In some embodiments, the sensor data includes data that describes the locations of objects and obstacles around the autonomous mobile robot in a two-dimensional space and/or a three-dimensional space. The autonomous mobile robot may determine characteristics of the trailer based on the sensor data. For example, the autonomous mobile robot may determine the width, height, depth, centerline, off-center parking, yaw, roll, and/or pitch of the trailer.

Additionally, the autonomous mobile robot may determine its location relative to the trailer based on the sensor data. For example, the autonomous mobile robot may identify some point or part of the trailer and determine its location with respect to that point or part. The autonomous mobile robot may use the sensor data determine its location and orientation relative the trailer. Furthermore, the autonomous mobile robot may identify objects in the trailer and may determine poses of the objects. For example, the autonomous mobile robot may identify pallets, including the types of the pallets, and may determine their location and orientation within the trailer. In some embodiments, the autonomous mobile robot continually determines its location, and the locations of objects and obstacles, based on continually received sensor data. The autonomous mobile robot may continually receive sensor data on a regular or irregular basis.

In some embodiments, the autonomous mobile robot uses a machine-learning model (e.g., a neural network) to determine characteristics of the trailer based on sensor data. For example, the machine-learning model may be a computer-vision model that has been trained to determine characteristics of a trailer based on image data captured by a camera on the autonomous mobile robot. Similarly, the machine-learning model may be trained to determine the location and orientation of objects within the trailer based on sensor data.

The autonomous mobile robot may enter the trailer and use sensor data of the trailer to determine the autonomous mobile robot's location with respect to the trailer. Additionally, the autonomous mobile robot may determine the location of the objects in the trailer, and any obstacles in the trailer, with respect to the trailer based on the sensor data. The autonomous mobile robot identifies an object to unload from the trailer and manipulates the object using a forklift component. In some embodiments, while the autonomous mobile robot navigates within the trailer, the autonomous mobile robot travels slightly offset from a centerline of the trailer so that the autonomous mobile robot is more likely to be in a correct position to manipulate an object within the trailer. In these embodiments, by remaining slightly offset from the centerline of the trailer, the autonomous mobile robot will likely be able to position its forks to lift an object by simply side-shifting its forks.

In some embodiments, the autonomous mobile robot uses an enhanced navigation algorithm while navigating within the trailer. An enhanced navigation algorithm may enable the autonomous mobile robot to determine its location more accurately within the trailer and to determine more accurately the locations of objects and obstacles within the trailer. The enhanced navigation algorithm may be more precise than a navigation algorithm used by the autonomous mobile robot while the autonomous mobile robot navigates within the warehouse environment. In some embodiments, the enhanced navigation algorithm uses a map within the trailer that has a finer resolution than the environment map. Similarly, the enhanced navigation algorithm may use denser motion primitives to navigate within the trailer than a navigation algorithm used by the autonomous mobile robot when navigating within the warehouse environment. In some embodiments, the enhanced navigation algorithm uses a modified version of A* search to navigate within the trailer. Furthermore, the enhanced navigation algorithm may use sensor data with a narrower field of view than the sensor data used a navigation algorithm used while the autonomous mobile robot navigates within the warehouse environment.

The autonomous mobile robot may detect when it has entered the trailer and may start using an enhanced navigation algorithm upon determining that it has entered the trailer. The autonomous mobile robot may use the enhanced navigation algorithm to position itself to manipulate objects within the trailer and to transport an object out of the trailer. Furthermore, the autonomous mobile robot may detect when it has exited the trailer and stop using an enhanced navigation algorithm upon determining that it is no longer in the trailer.

In some embodiments, the autonomous mobile robot uses a first navigation algorithm to determine a route from a first pose in the warehouse environment to a second pose near an entrance to the trailer. The autonomous mobile robot may then use a second navigation algorithm to determine a route from the second pose to a third pose within the trailer from which the autonomous mobile robot can manipulate an object. The first navigation algorithm may be a navigation algorithm that the autonomous mobile robot uses to navigate within the warehouse environment and the second navigation algorithm may be an enhanced navigation algorithm that the autonomous mobile robot uses to determine its location within the trailer. Thus, the second navigation algorithm may be a navigation algorithm with a higher level of precision than the first navigation algorithm. For example, the second navigation algorithm may use a map with a finer resolution or may use more precise or dense motion primitives to determine a route.

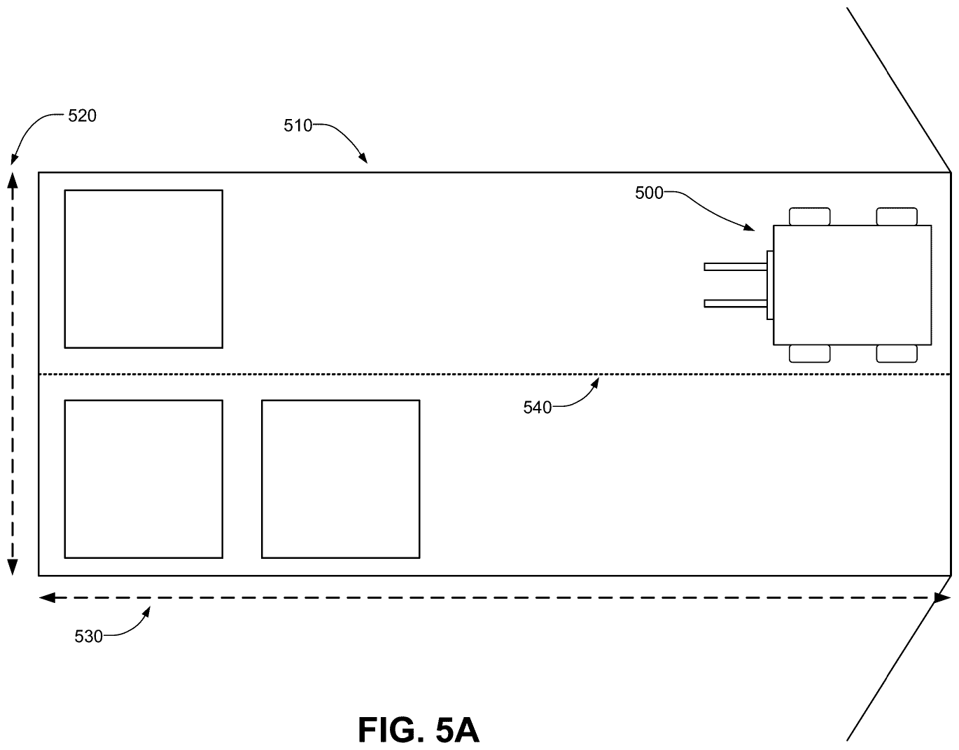

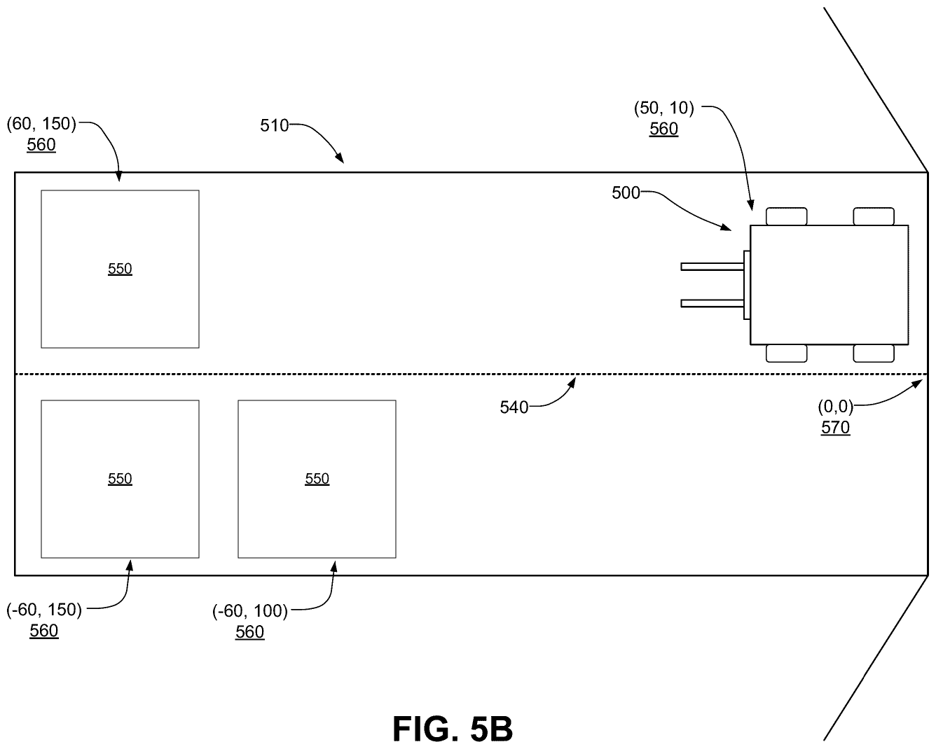

FIGS. 5A and 5B illustrate an example autonomous mobile robot 500 navigating within a trailer 510 and determining characteristics of the trailer 510, in accordance with some embodiments. FIG. 5A illustrates example characteristics that the autonomous mobile robot 500 may determine based on sensor data. For example, the autonomous mobile robot 500 may determine a width 520 and a depth 530 of the trailer 510. Additionally, the autonomous mobile robot 20 may determine the location of a centerline 540 of the trailer 510.

FIG. 5B illustrates example locations 560 of the autonomous mobile robot 500 and objects 550 within the trailer 510, as determined by the autonomous mobile robot 500. The autonomous mobile robot 500 determines the locations 560 of itself and objects 550 relative to the trailer 510. In the embodiment illustrated in FIG. 5B, the locations 560 of the autonomous mobile robot 500 and the objects 550 are determined relative to an origin location 570, however alternative embodiments may determine locations 560 within the trailer 510 relative to any part of the trailer 510.

The autonomous mobile robot generally must unload the last row of the trailer first. In some embodiments, the autonomous mobile robot determines whether the trailer is full and, responsive to determining that the trailer is full, determines that it must unload the last row of the trailer. As used herein, the last row of the trailer is the row that is closest to the doors through which the autonomous mobile robot enters to load or unload the trailer. When the autonomous mobile robot prepares to unload the last row of the trailer, the autonomous mobile robot generally must manipulate the objects in the last row from a ramp that connects the warehouse to the trailer. Therefore, the autonomous mobile robot accounts for the angle of the ramp while approaching the objects.

The autonomous mobile robot uses sensor data to monitor its location relative to the object. Additionally, the autonomous mobile robot may use accelerometer or gyroscopic data to determine its orientation on the ramp and to thereby adjust the orientation of a forklift component coupled to the autonomous mobile robot. The autonomous mobile robot adjusts its forklift components to ensure that the forks are level with respect to the floor of the trailer, rather than the ramp. The autonomous mobile robot thereby ensures that the forks are in the correct orientation to manipulate a pallet. The robot may continually adjust its forks as it approaches the object. For example, the autonomous mobile robot may continually gather new sensor data about its surroundings to continually determine its location and pose with respect to an object in the last row of the trailer and continually adjust its forklift component.

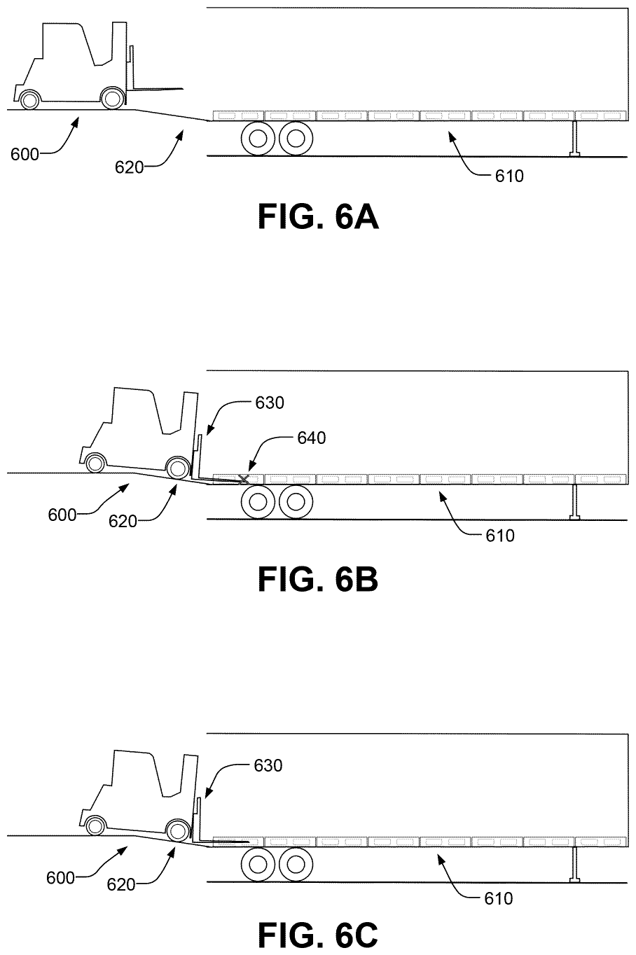

FIGS. 6A-6C illustrate an example autonomous mobile robot 600 unloading objects in the last row of a trailer 610, in accordance with some embodiments. FIG. 6A illustrates an autonomous mobile robot 600 approaching a ramp 620 that leads from the warehouse to the trailer 610. FIG. 6B illustrates an autonomous mobile robot 600 attempting to unload an object in the last row of the trailer 610 without adjusting its forklift 630. The forklift 630 remains level with respect to the ramp 620, meaning that the forks of the forklift 630 would collide 640 with the floor of the trailer 610. FIG. 6C illustrates an autonomous mobile robot 600 that adjusts its forklift 630 to be level with the floor of the trailer 610. By continually adjusting its forklift 630 as it travels down the ramp 620, the autonomous mobile robot 600 ensures that its forklift 630 is able to manipulate an object in the last row of the trailer 610 without having to maneuver itself significantly.

While performing an unload mission, the autonomous mobile robot continues to unload objects from a trailer to a destination area within the warehouse until the trailer is empty. In some embodiments, the autonomous mobile robot determines that the trailer is empty by navigating to the trailer, collecting sensor data of the interior of the trailer, and determining that there are no more objects in the trailer.

In some embodiments, the autonomous mobile robot continues to determine its location with respect to environment map of the warehouse while also determining its location with respect to the trailer. The autonomous mobile robot may use its location with respect to the trailer for navigating within the trailer. However, by continuing to track its location with respect to the environment map, the autonomous mobile robot can more quickly return to navigating with respect to the environment map.

To continue to determine its location with respect to the environment map while navigating within the trailer, the autonomous mobile robot may determine the location of the trailer with respect to the warehouse. For example, the autonomous mobile robot may capture images of the entrance of the trailer and/or of the entire exterior of the trailer. The autonomous mobile robot may then determine the location of the trailer with respect to the warehouse based on these captured images. The autonomous mobile robot may then continue to determine its location with respect to the environment map based on the determined location of the trailer with respect to the warehouse. The autonomous mobile robot performs a mission to load a trailer in a similar manner to how the autonomous mobile robot unloads a trailer. In some embodiments, the autonomous mobile robot performs an “empty run” of the trailer, where the autonomous mobile robot travels into a trailer that is to be loaded to collect sensor data and determine characteristics of the trailer. The autonomous mobile robot may perform this “empty run” without carrying any objects from a source area.

To load the trailer, the autonomous mobile robot identifies an object in a source area to load onto the trailer. The autonomous mobile robot picks up the object and navigates from the source area to the trailer. The autonomous mobile robot determines whether the object needs to be loaded in the last row of the trailer. If the object does not need to be placed in the last row of the trailer, the autonomous mobile robot enters the trailer and identifies a location in the trailer where the object will be placed. In some embodiments, the autonomous mobile robot travels within the trailer slightly offset from a centerline of the trailer so that the autonomous mobile robot is more likely to be in a correct pose to deliver the object to a proper location within the trailer.

If the object needs to be placed in the last row of the trailer, the autonomous mobile robot will continually collect sensor data to determine a correct orientation of its forklift such that the object is delivered level with the floor of the trailer. The autonomous mobile robot continually adjusts the orientation of its forklift until the autonomous mobile robot delivers the object to a proper spot in the last row of the trailer.

The autonomous mobile robot may include components that enable the autonomous mobile robot to navigate within the trailer. For example, the autonomous mobile robot may include a movement system that enables the autonomous mobile robot to rotate in place. Similarly, the autonomous mobile robot may be configured to move to perpendicularly to the direction it is facing without changing its orientation. Thus, the autonomous mobile robot is capable of navigating within often narrow spaces within a trailer and to position itself to be able to manipulate objects within the trailer.

Furthermore, the autonomous mobile robot may include components that enable the autonomous mobile robot to manipulate objects within the trailer. For example, the autonomous mobile robot may include a forklift with the ability to side-shift. Thus, the autonomous mobile robot can position the forklift to manipulate objects without having to reposition itself. The autonomous mobile robot may also include an arm that can lift objects while the autonomous mobile robot maintains a fixed pose. Thus, the autonomous mobile robot can effectively manipulate objects within the trailer from the often limited poses available within the trailer.

### Example Centerline Heuristic-Based Path Finding

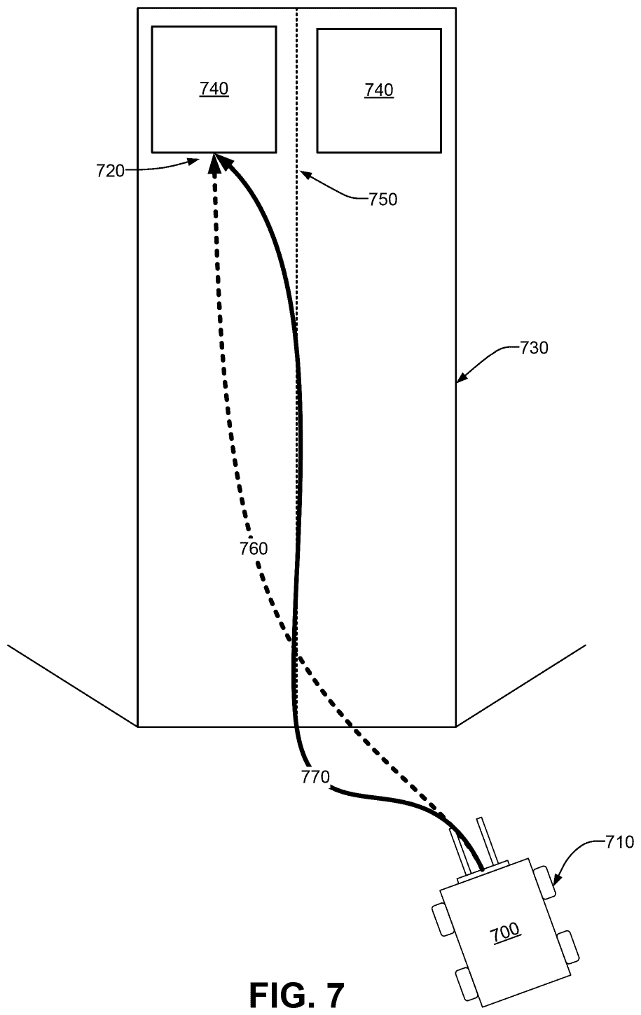

FIG. 7 illustrates an example autonomous mobile robot that uses a centerline heuristic to navigate within a trailer, in accordance with some embodiments. While the FIG. 7 illustrates an autonomous mobile robot entering a trailer, a similar process may be used for an autonomous mobile robot exiting the trailer, as well.

The autonomous mobile robot 700 receives sensor data describing the environment around the robot. The autonomous mobile robot 700 may receive the sensor data from sensors coupled to the robot (e.g., the robot sensor module 331) or from sensors remote from the autonomous mobile robot.

The autonomous mobile robot 700 determines an initial pose 710 of the autonomous mobile robot 700 and an end pose 720 for the autonomous mobile robot 700 based on the received sensor data. The initial pose 710 of the autonomous mobile robot 700 may be a current pose of the autonomous mobile robot, or a pose near the entrance of a trailer 730. The end pose 720 may be a pose for handling an object 740 (e.g., an item on a pallet) within the trailer 730. In some embodiments, the autonomous mobile robot 700 determines the end pose based on instructions from a central communications system.

The autonomous mobile robot 700 computes a centerline 750 of the trailer 730 based on the received sensor data. The centerline is a centerline of the trailer (i.e., is a line that is equidistant from the sides of the trailer). In some embodiments, the autonomous mobile robot 700 generates a map of the interior of the trailer based on the sensor data and computes the centerline based on the generated map.

FIG. 7 illustrates an example path 760 from the initial pose 710 to the end pose 720 that is computed without a centerline heuristic. The autonomous mobile robot may compute the path 760 using a pathfinding algorithm, such as Hybrid A* or State Lattice Planner. A pathfinding algorithm may use heuristics to compute a path from a first pose to a second pose. For example, a pathfinding algorithm may use a heuristic to represent a cost of a set of nodes through which the autonomous mobile robot 700 may pass as part of the path. These nodes may be coordinates or locations within the trailer through which the robot may pass as part of a computed path. The heuristic may have a higher cost for a “worse” node than for a “better” node. For example, a common heuristic is the distance from a node to the end pose, and the heuristic may thereby compute a higher cost (i.e., distance) for a node that is further away from the end pose than a node that is closer to the end pose. The pathfinding algorithms compute a path through nodes that minimize the total cost of the nodes that the path passes through.

As illustrated in FIG. 7, a path 760 that uses traditional heuristics is likely to take a more direct path to the end pose 720. While this may mean that the autonomous mobile robot 700 takes a shorter path, the path 760 may take the autonomous mobile robot 700 closer to the sides of the trailer 730, especially if the end pose 720 is closer to one side of the trailer 730 than the other. This may reduce the space that the autonomous mobile robot 700 has to maneuver if the autonomous mobile robot 700 has to change course within the trailer 730.

FIG. 7 illustrates a path 770 computed using a centerline heuristic. A centerline heuristic is a heuristic that represents a distance of nodes to the centerline 750. For example, the centerline heuristic may increase the cost of a node that is further from the centerline 750 relative to a node that is closer to the centerline 750. In some embodiments, the centerline heuristic assigns a cost value to a node that is proportional to the distance of the node to the centerline of the trailer. Alternatively, the centerline heuristic may assign a constant cost value to nodes within some threshold distance of the centerline, and may assign cost values to other nodes that is proportion to their distance from the centerline minus the threshold distance. In other words, the centerline heuristic may assign cost values to nodes such that nodes within some area (e.g., a rectangular area) around the centerline are constant, and that nodes outside the area are assigned cost values that are proportional to their distance from the area.

The autonomous mobile robot 700 may use a combination of multiple heuristics to compute the path 770 to the end pose 720. For example, the autonomous mobile robot 700 may compute a combination of the centerline heuristic, a heuristic representing a distance of a node to the end pose 720, and a heuristic representing a distance of a node to an obstacle. Thus, the autonomous mobile robot 700 may compute a combined cost for each node that is a function (e.g., a linear combination) of multiple heuristics.

As explained above, the autonomous mobile robot 700 computes the path 770 from the initial pose 710 to the end pose 720 based on the centerline heuristic. The autonomous mobile robot 700 travels along the path 770 to the end pose 720. The autonomous mobile robot 700 may manipulate an object 740 at the end pose 720, such as lifting the object to transport. The autonomous mobile robot 700 may perform a similar process to compute a path to exit the trailer 730.

### Navigating Between Piecewise Flat Segments in Model-Based Mode

As described above, some environments contain multiple interconnected piecewise flat segments, where the floor includes several flat sections connected at various angles, resulting in a series of transitions between different surfaces. These environments can pose hazards to autonomous mobile robots because the segments do not form a smooth, continuous surface; instead, each segment may be inclined at a different angle relative to the adjacent segments. This scenario is common in locations such as ramps, loading docks, or areas where the floor must accommodate elevation changes or different structures. For instance, the transition between a warehouse floor and a trailer during loading or unloading often involves several flat segments with slight inclines between them.

In some embodiments, the autonomous mobile robot is configured to operate in a model-based mode, where a model of each piecewise flat segment is provided and transmitted to the robot 140. The controller 336 leverages these models to guide the navigation of the robot 140 across the different piecewise flat segments, ensuring that robot 140 adjusts its movement and fork position according to the specific geometry of each segment. This approach allows the robot to navigate complex environments more efficiently by anticipating changes in the floor surface, reducing the need for real-time sensing adjustments.

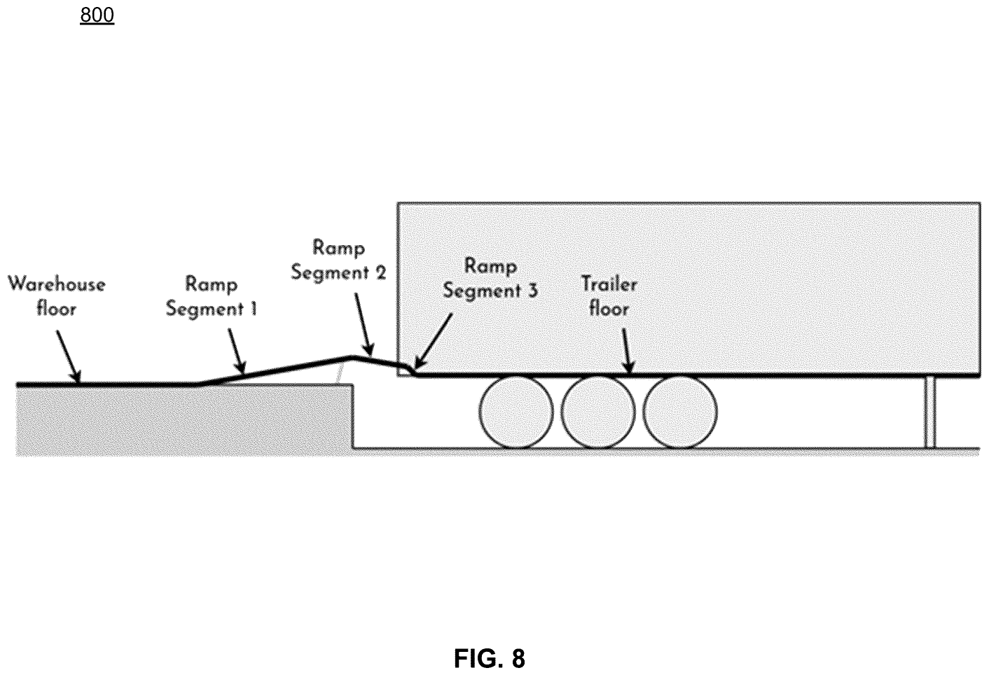

FIG. 8 illustrates an example environment 800 in which a floor includes multiple piecewise flat segments. The multiple piecewise flat segments include a warehouse floor, a ramp segment 1, a ramp segment 2, a ramp segment 3, and a trailer floor. The warehouse floor is a flat surface of the warehouse, and the trailer floor is a flat surface of a trailer. A ramp connecting the two the warehouse floor and the trailer includes three segments (namely, ramp segment 1, ramp segment 2, and ramp segment 3), each having a different angle. An autonomous mobile robot navigating between the warehouse floor and trailer floor must pass through the three ramp segments.

As illustrated in FIG. 8, the trailer floor appears to be horizontal. However, in some situations, the trailer floor is often not horizontal due to various practical and structural reasons. For instance, trailers are frequently used in loading and unloading operations at docks of differing heights. To accommodate these variations, the trailer floor may be slightly inclined or sloped to align with the dock height and facilitate loading and unloading operations. Further, the ramp segments leading to the trailer or within the loading area may also vary in shape and slope.

The varying shapes and slopes of the ramp segments, combined with the potential incline or slope of the trailer floor, can create significant challenges for autonomous mobile robots. As the robot transitions from the warehouse floor to the trailer, it must navigate through the different angles of each ramp segment and account for the trailer's angled surface. These changes in elevation and geometry can lead to collisions, with the forks potentially hitting or getting stuck on the floor, especially if the robot fails to adjust its height or tilt in response to the varying surfaces.

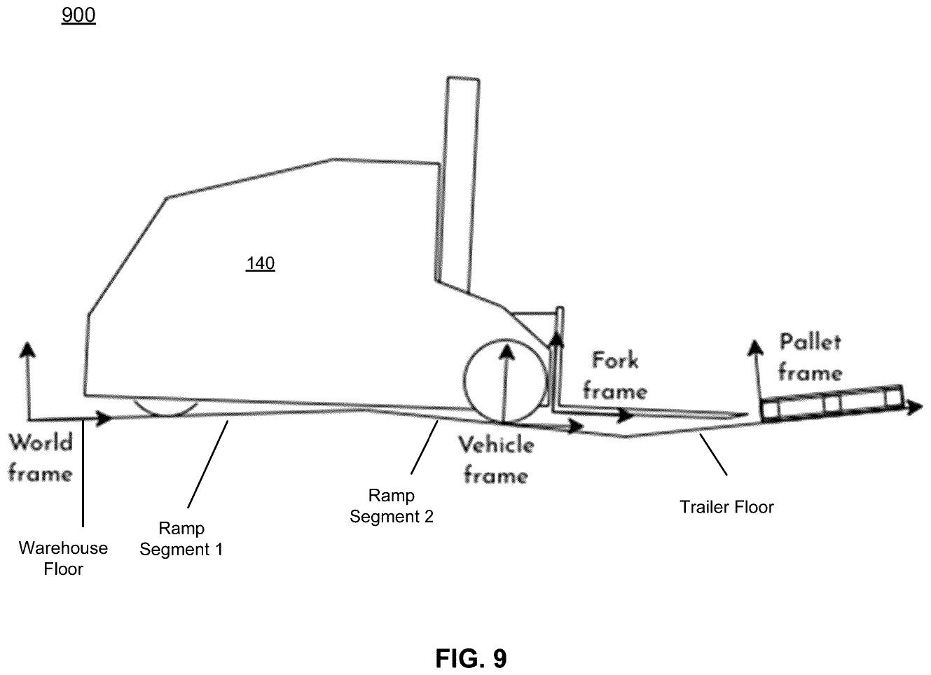

FIG. 9 illustrates an example environment 900 in which an autonomous mobile robot 140 interacts with a pallet in an environment with multiple piecewise segments, e.g., warehouse floor, ramp segment 1, ramp segment 2, and trailer floor. Notably, there are multiple reference frames involved when the autonomous mobile robot 140 moves across angled piecewise segments. The world frame represents the global coordinate system fixed relative to the ground in the environment where the robot 140 is operating. When the warehouse floor is horizontal, the world frame is in parallel with the plane of the warehouse floor. The vehicle frame is attached to and moves with the autonomous mobile robot 140. The fork frame aligns with the direction in which the forks are extending, while the pallet frame corresponds to the orientation of the pallet. Because the pallet is aligned with the angle of trailer floor, the pallet frame reflects a pitch of the trailer. As the front wheel of the robot 140 is positioned on ramp segment 2 and the rear wheel remains on ramp segment 1, the vehicle frame adopts an orientation based on the angle formed by the positions of the front and rear wheels, which is between the orientations of the ramp segment 1 and ramp segment 2.

As described above, the angle of the fork (i.e., fork frame) is adjustable independent from the vehicle frame. The autonomous mobile robot 140 may adjust the height and/or angle of the fork to allow the fork to pass through the ramp segments and trailer floor without hitting the floor.

In some embodiments, the autonomous mobile robot 140 operates in a model-based mode, in which the robot 140 utilizes a pre-built or real-time generated model of an environment to predict and plan its movement. In some embodiments, the robot 140 receives a model of an environment, including models of each of the piecewise segments from the central communication system 130. The models including angles and geometries of each piecewise segment and their interconnections. The robot 140 uses a combination of sensors (e.g., LIDAR, cameras, IMU, GPS, and/or odometry) to continuously track its position in the environment in real time. The robot 140 uses its sensors to estimate its pose (e.g., position and orientation) within each segment of the environment. The robot 140 determines its location, including which segment it is on (e.g., warehouse floor, ramp segment 1, ramp segment 2, etc.). The robot 140 also determines how far it has traveled along a segment and where a next transition will occur. For instance, if the robot 140 has traveled half way along ramp segment 1, it determines how much more distance it has before transitioning to ramp segment 2. The robot 140 continuously updates its location using sensor feedback in relation to the model.

The robot 140 adjusts its operation parameters based on its pose in the environment and the model of the environment. In some embodiments, the robot 140 is programmed with one or more reference constraints, such as maintaining a minimum distance between the fork (e.g., the tip of the fork) and the floor, as well as ensuring the tilt angle of the fork does not exceed a maximum allowable limit. As the robot 140 navigates through varying floor conditions, it continuously adjusts its operation parameters to ensure that these reference constraints are consistently met, thereby preventing potential collisions or mishandling of the load.

In some embodiments, the operation parameters includes a height and/or a tilt of the forks. In some embodiments, the operation parameters may also include speed and moving direction. For instance, if the front wheel of the robot 140 are on ramp segment 1 while the rear wheels are still on the warehouse floor, the robot 140 recognizes this transitioning state and adjusts its operation parameters accordingly. For example, the robot 140 may determine that the fork needs to be lifted higher or tilted upward to maintain the minimum distance between the tip of the fork and the floor. In some embodiments, the robot 140 may also reduce its speed due to the detected transitioning state between two different piecewise flat segments.

Further, based on the model, the robot 140 can predict upcoming floor changes. For example, as illustrated in FIG. 9, the model may indicate an upcoming trailer floor having a certain angle. Based on this, the robot 140 may adjust the fork height and/or tilt in advance, preventing the fork from hitting the trailer floor.

In some embodiments, when a piecewise segment does not have an existing model available, the autonomous mobile robot 140 may use its onboard sensors to construct one. The sensors may include LIDAR, 3D cameras, ultrasound, and other distance or depth sensors. For example, the sensors can scan the environment as it moves, collecting data on the position and orientation of the surface around itself.

In some embodiments, the robot 140 may transmit the sensor data back to the central communication system 130, which in turn construct a model of the environment based on the received sensor data. The model may be a three-dimensional representation of each piecewise segment and their interconnections. Alternatively, the robot 140 uses the sensor data to construct a model itself, and transmits the constructed model back to the central communication system 130. In either case, when another robot 140 moves across the same environment, the central communication system 130 may transmit the model of the environment to that robot 140, such that that robot 140 can use the model to navigate through the environment without having to reconstruct the model again.

In some embodiments, the model also includes a height of the environment, e.g., a height of a trailer. The robot 140 may also receive data about a dimension of a load. Based on the height and pitch of the trailer, and the dimension of the load, the robot 140 may further adjust the height and tilt of the forks to prevent the load from hitting the ceiling of the trailer.

### Navigating Between Piecewise Flat Segments in Closed-Loop Mode

In some embodiments, the robot 140 can operate in a closed-loop mode. In closed-loop mode, the robot 140 does not rely on any model of the environment to navigate or adjust its operation parameters. Instead, it uses real-time sensor feedback to react to the current conditions of its surroundings, particularly in environment with complex geometries such as ramps, or uneven floors between areas.

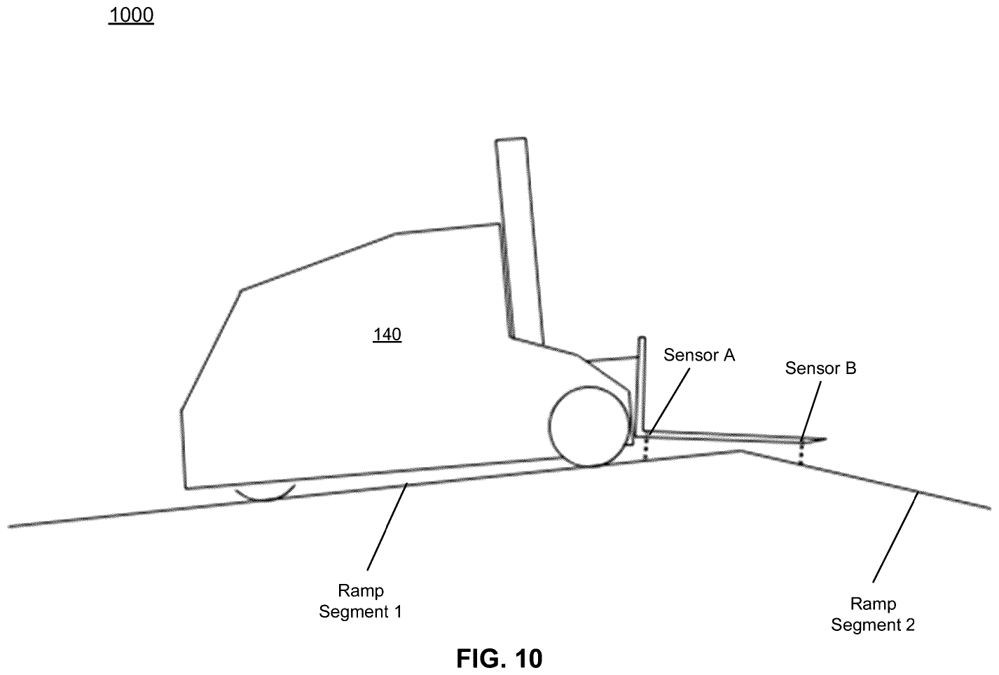

FIG. 10 illustrates an example environment 1000, in which an autonomous mobile robot 140 operates in a closed-loop mode. As illustrated, there are two sensors, sensor A and sensor B positioned at a proximal end and a distal end of a fork of the robot 140. Each of the sensors A and B is configured to detect a distance between the fork and floor. As the robot 140 moves across different piecewise flat segments, the sensors A and B continuously measure the distance between the fork and the floor.

In some embodiments, these sensors may be ultrasonic sensors that use sound waves to measure the distance to the floor by emitting a sound pulse and timing how long it takes for the pulse to reflect back. In some embodiments, the sensors may be infrared (IR) sensors that project infrared light and measure the reflection of the infrared light to determine the distance between the fork and the floor. In some embodiments, the sensors may be time-of-flight (ToF) sensors that measure the time it takes for light to travel to an object and reflect back to the sensor. In some embodiments, the sensors are LIDAR sensors that use laser light to measure distances and generate detailed data on the surrounding environment.

When the difference between the distances detected by sensors A and B increases and exceeds a predetermined threshold, the robot 140 determines that it is transitioning from a first piecewise segment to a second piecewise segment (e.g., from ramp segment 1 to ramp segment 2). For instance, if the distance detected by sensor B is greater than that detected by sensor A, the robot 140 may infer that the second piecewise segment is sloping downward, prompting the robot 140 to lower its fork to maintain optimal positioning. Conversely, if the distance detected by sensor B is less than that detected by sensor A, the robot 140 may infer that the second piecewise segment is sloping upward, and will raise the height and adjust the tilt of its fork to avoid contact with the floor.

In some embodiments, the robot 140's controller is programmed with one or more reference constraints, such as the minimum distance between the fork and the floor, the maximum tilt angle of the fork, the maximum tilt angle of the vehicle frame, and the maximum allowable angle difference between two piecewise flat segments. These reference constraints may be set by a system administrator or derived from previous operational data. As the robot 140 navigates across the piecewise flat segments, the controller continuously monitors the robot 140's state to ensure that each reference constraint is met. For example, the robot 140 can measure the distance between both ends of the fork and the floor, and based on the difference between these distances, it can determine the relative angle between the segments. Additionally, the robot 140 can use an inertial measurement unit (IMU) to calculate the tilt angle of both the vehicle frame and the fork. Based on these measurements, the controller assesses whether the reference constraints are satisfied and adjusts the operation parameters as necessary to maintain compliance with those constraints.

For certain tasks, such as entering pallet pockets, the reference height is maintained to allow smooth entry without raising the fork too high and missing the pallet. In some embodiments, particularly with pallets that have bottom bars, the robot 140 may detect a sudden change in floor height as it enters the pallet pocket. Here, the controller may be programmed to maintain the fork height, ignoring the detected jump, to ensure successful pallet engagement.

In certain scenarios, the vehicle may encounter concave or abrupt changes in the floor's geometry. If the robot 140 detects that the angle between two segments is too steep (above a threshold), it can stop before striking the floor. The robot 140 can also take alternate paths to avoid potential obstacles, such as concave dips in the floor.

As such, in this model-free, closed-loop mode, the autonomous mobile robot 140 is able to navigate through complex environments by relying on real-time sensor feedback to control fork height and tilt.

In some embodiments, the robot 140 records a sequence of sensor measurements along with corresponding vehicle and fork poses while navigating through the environment in closed-loop mode. Using the recorded sensor data from various locations, the robot 140 can connect the measurement points with line segments and calculate the angles between those segments. Over time, the robot 140 can estimate or construct a model of the floor's geometry based on these calculations. In response to determining that the model reaches a predetermined confidence level, the robot 140 can switch from closed-loop mode to model-based mode.

In some embodiments, the robot 140 may perform simulations or generate predictions based on the current model and compare them with real-time sensor data. If the predicted geometry from the model consistently aligns with the sensor data, the model is considered reliable. The confidence level is determined by evaluating the variation between the sensor data and the model's predictions. As the variation decreases, the confidence level increases. The predetermined confidence level is achieved when the variation falls below a defined threshold.

In model-based mode, the robot 140 may be able to navigate more efficiently, requiring fewer computational resources and consuming less battery power, thereby increasing operational speed and performance.

### Combination of Model-Based Mode and Closed-Loops Mode

In some embodiments, the autonomous mobile robot 140 operates using both model-based and closed-loop (model free) modes, switching between them as necessary to optimize navigation, load handling, and battery usage. The robot 140's controller dynamically determines which method to use based on the specific environment and the reliability of available data. In areas where the robot 140 has a high-confidence model of the environment (e.g., a warehouse or trailer with known geometry), the controller leverages the model to predict the movements needed for optimal navigation. This includes predicting the angles and heights of piecewise segments (such as ramps or uneven floors), allowing the robot 140 to adjust its forks preemptively for smoother and more efficient operations.

However, if a model is unavailable, incomplete, or has a low confidence score (for instance, when the robot 140 encounters new or dynamically changing environment), the controller can switch to a model-free mode. in this mode, the robot 140 relies on real-time sensor feedback, such as distance sensors, LIDAR (light detection and ranging), or cameras, to adjust its movements based on immediate surroundings. This allows the robot 140 to react to unforeseen changes or unmodeled segments in the environment.

In some embodiments, the controller continuously monitors the confidence level in the model's accuracy. When the robot 140 enters an area where the model's confidence level is lower than a threshold (e.g., due to new slopes, ramps, or obstacles), the controller toggles to closed-loop mode. In this mode, the robot 140 relies entirely on sensor data to make real-time adjustments to fork height, tilt and position to safely navigate through the environment. Conversely, when the controller determines that the environment is well modeled and predictable, and/or confidence in the model's accuracy improves (e.g., after re-entering a familiar, pre-modeled area or as more data is gathered), the robot 140 toggles back to the model-based approach. This allows the robot 140 to rely on pre-modeled geometries for more efficient movement planning, reducing computational load and battery usage.

By alternating between these modes, the robot 140 can navigate a variety of environments—both known and unknown—while optimizing performance, ensuring safety, and preserving battery life. The combined mode enhances the robot 140's flexibility and operational efficiency by allowing it to seamlessly adapt to different environments or tasks.

### Fork and Pallet Alignment

In some embodiments, the robot 140 determines a vehicle pose, a fork pose, and a pallet pose based on the sensor data and/or model. The fork pose corresponds to a fork line, and the pallet pose corresponds to a pallet line. The robot 140 determines a set of operation parameters to minimize a distance between the fork line and pallet line as the robot 140 approaches the pallet.

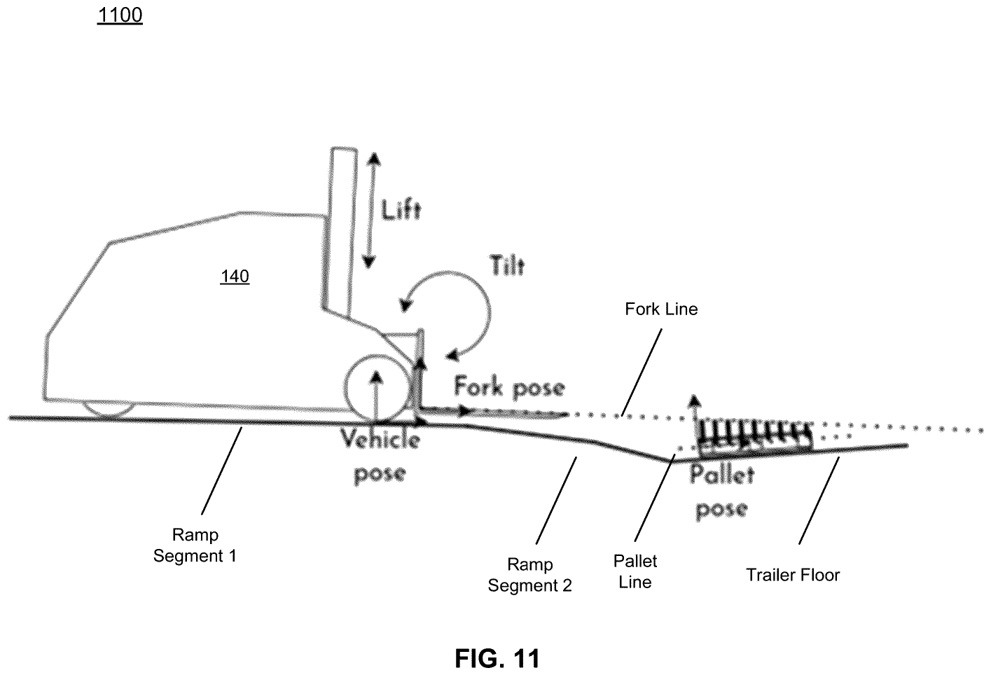

FIG. 11 illustrates an example environment 1100, in which an autonomous mobile robot 140 adjusts lift and tilt of forks to align the forks with a pallet, in accordance with one or more embodiments. The robot 140 determines the vehicle pose, fork pose, and pallet pose, which may be based on a model or sensor data. The vehicle pose represents the position and orientation of the autonomous mobile robot 140, while the fork pose indicates the position and orientation of the fork. The pallet pose reflects the position and orientation of the pallet. In this scenario, the robot 140 is positioned on ramp segment 1, the fork on ramp segment 2, and the pallet on the trailer floor. The fork line represents the direction in which the forks extend, while the pallet line runs along the center of the pallet. As the robot 140 approaches the pallet, it adjusts the lift and tilt of the forks to align the fork line with the pallet line. Once aligned, the robot 140 can advance or extend the forks into the pallet pockets to handle the load effectively. In addition to forks for handling pallets, autonomous mobile robots 140 may be equipped with a variety of other load handling mechanisms. For example, grippers can be used to grasp and transport irregularly shaped objects, while vacuum lifters are suitable for handling flat, smooth surfaces like glass or sheet metal. Clamps can securely hold large containers or bundles. Each of these load handling mechanisms may operate on similar principles of precise positioning, alignment, and sensor-based feedback to ensure accurate handling in confined or constrained spaces, much like forklifts managing pallets.

### Example Method for Navigation of Autonomous Mobile Robot in Model-Based Mode

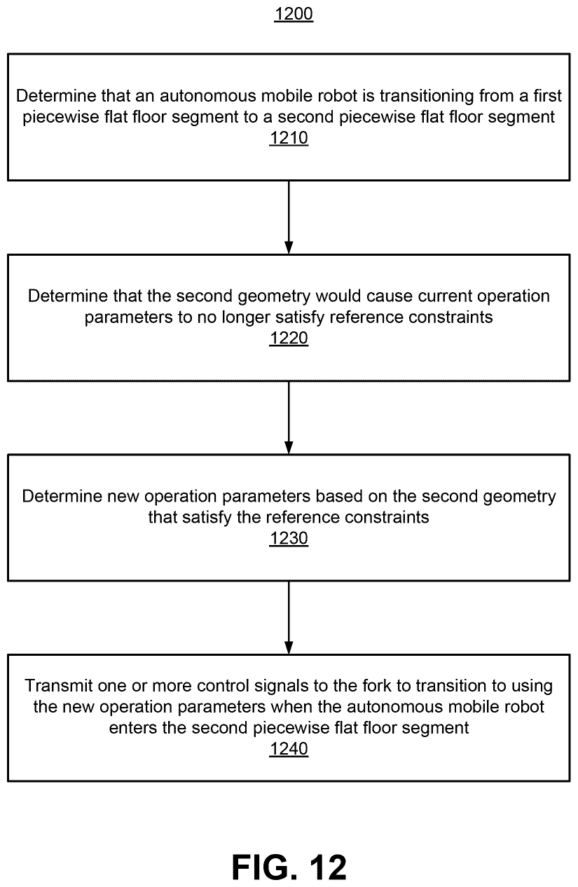

FIG. 12 is a flowchart of an example method 1200 for navigating an autonomous mobile robot across multiple piecewise flat floor segments in a model-based mode, in accordance with some embodiments. Alternative embodiments may include more, fewer, or different steps, and the steps may be performed in a different order from that illustrated in FIG. 12. Additionally, while FIG. 12 is primarily described in terms of actions taken by an autonomous mobile robot (e.g., robot 140), the steps may be performed, in part or in whole, by a central communication system in communication with an autonomous mobile robot.

The autonomous mobile robot 140 determines 1210 that it is transitioning from a first piecewise flat floor segment having a first geometry to a second piecewise flat floor segment having a second geometry based on sensing data generated by one or more sensors integrated with the fork. For example, the robot 140 may be transitioning from a warehouse to a trailer via a ramp. Each of a warehouse floor, the ramp, and a trailer floor may be a piecewise flat floor segment having different geometries.

In some embodiments, the one or more sensors include one or more of LIDAR, stereo camera, 2D camera, 3D camera, ultrasound sensor, inertial measurement unit, GPS, and/or time-of-flight camera. In some embodiments, the fork is set to operation parameters that satisfy reference constraints. In some embodiments, the reference constraints include a minimum distance between the fork from a floor and/or a maximum allowable tilt angle, and the operation parameters include a height and/or a tilt of the fork.

The autonomous mobile robot 140 determines 1220 that the second geometry would cause the operation parameters to no longer satisfy the reference constraints. The autonomous mobile robot 140 determines 1230 new operation parameters based on the second geometry that satisfy the reference constraints. The autonomous mobile robot 140 transmits 1240 one or more control signals to the fork to transition to using the new operation parameters when the autonomous mobile robot 140 enters the second piecewise flat floor segment.

For example, the robot 140 may detect that the distance between the fork and the floor falls below the minimum threshold during the transition from the first segment to the second segment based on the current operation parameters. In this case, the robot 140 increases the height of the fork or increases the tilt of the fork to maintain the required clearance. Similarly, the robot 140 may determine that the tilt angle of the fork exceeds the allowable limit during the transition. In such a scenario, the robot 140 adjusts the tilt angle to ensure it stays within the maximum permissible tilt angle.

In some embodiments, after the robot 140 picks up a pallet with a stacked load (referred to simply as a pallet), it assesses the geometry of the pallet and updates its operation parameters accordingly. These adjustments ensure that both the pallet on the forks and the robot 140 itself maintain adequate clearance from overhead obstacles while navigating across piecewise flat floor segments. For instance, the robot 140 may consider geometry data about the trailer, such as the trailer's height. Based on this data, the robot 140 modifies the operation parameters to ensure that the pallet carried by the forks maintains sufficient clearance from the trailer's ceiling during the transition.

### Example Method for Navigating an Autonomous Mobile Vehicle in Closed-Loop Mode

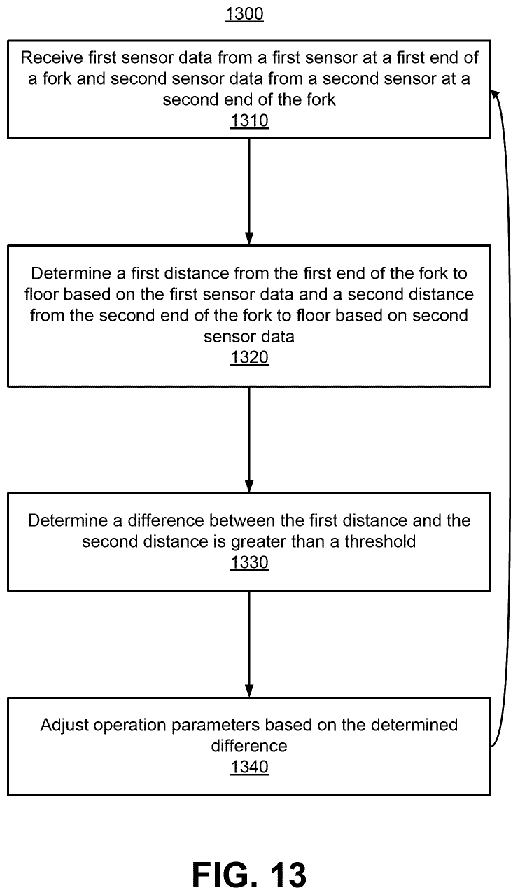

FIG. 13 is a flowchart of an example method 1300 for navigating an autonomous mobile robot across multiple piecewise flat floor segments in a closed-loop mode, in accordance with some embodiments. Alternative embodiments may include more, fewer, or different steps, and the steps may be performed in a different order from that illustrated in FIG. 13. Additionally, while FIG. 13 is primarily described in terms of actions taken by an autonomous mobile robot (e.g., robot 140), the steps may be performed, in part or in whole, by a central communication system in communication with an autonomous mobile robot.

An autonomous mobile robot 140 receives 1310 first sensor data from a first sensor at a first end of a fork and second sensor data from a second sensor at a second end of the fork. Referring to FIG. 10, sensor A is positioned at a proximal end of the fork, and sensor B is positioned at a distal end of the fork. In some embodiments, these sensors may be ultrasonic sensors that use sound waves to measure the distance to the floor by emitting a sound pulse and timing how long it takes for the pulse to reflect back. In some embodiments, the sensors may be infrared (IR) sensors that use infrared light to detect the proximity or distance of floor. These sensors measure the reflection of the infrared light to determine the distance between the fork and the floor. In some embodiments, the sensors may be time-of-flight (ToF) sensors that measure the time it takes for light to travel to an object and reflect back to the sensor. In some embodiments, the sensors are LIDAR sensors that use laser light to measure distances and generate detailed data on the surrounding environment.

The autonomous mobile robot 140 determines 1320 a first distance from the first end of the fork to the floor using the first sensor data and a second distance from the second end of the fork to the floor using the second sensor data. For instance, as shown in FIG. 10, sensor A measures the first distance to the floor of ramp segment 1, while sensor B measures the second distance to the floor of ramp segment 2.

The autonomous mobile robot 140 determines 1330 whether a difference between the first distance and the second distance is greater than a threshold (also referred to a first threshold). Responsive to determining that the difference between the first distance and the second distance is greater than the threshold, the autonomous mobile robot 140 adjusts 1340 operation parameters based on the determined difference.

In some embodiments, the robot 140 records a sequence of sensor measurements along with corresponding vehicle and fork poses while navigating through the environment in closed-loop mode. Using the recorded sensor data from various locations, the robot 140 can connect the measurement points with line segments and calculate the angles between those segments. For example, the robot 140 may determine an angle of a second piecewise flat segment relevant to a first piecewise flat segment. In some embodiments, the robot 140 may determine updated operation parameters based on the angle.

As the robot 140 navigates across the different piecewise flat segments, it continuously generates sensing data to determine the distances between the two ends of the forks and the floor. This sensing data may be used to construct a model of the environment, which is dynamically updated as the robot 140 collects more information while moving. The robot 140 remains in the closed-loop mode until the model it has built reaches a confidence level greater than a predefined threshold. Alternatively, if the robot 140 navigates into an area where a reliable model is already available, it may switch to the model-based mode. In either case, the robot 140 toggles from the closed-loop mode to a model-based mode once the model becomes sufficiently reliable.

In some embodiments, when the difference between the first distance and the second distance exceeds a second threshold, which is larger than a predefined first threshold, it indicates a significant change in the floor geometry, such as a steep drop, abrupt shift, or an obstacle. Alternatively, it may suggest that the angle between the first and second piecewise flat segments surpasses a threshold. Upon detecting this large difference between the sensor readings, the robot 140 may halt and generate an alert as a preventive measure. This precaution helps the robot 140 avoid potential collisions with the floor or other obstacles that could occur if it continued without adjusting its forks or movement. The alert can prompt either a manual or automated intervention to reassess and modify the robot 140's path or settings before it resumes operation.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
determining that an autonomous mobile robot, having a fork configured to carry a pallet, is transitioning from a first piecewise flat floor segment having a first geometry to a second piecewise flat floor segment having a second geometry based on sensing data generated by one or more sensors integrated with the autonomous mobile robot, wherein the fork is set to operation parameters that satisfy reference constraints;
determining that the second geometry would cause the operation parameters to no longer satisfy the reference constraints;
determining new operation parameters based on the second geometry that satisfy the reference constraints; and
transmitting one or more control signals to the fork to transition to using the new operation parameters when the autonomous mobile robot enters the second piecewise flat floor segment.

2. The method of claim 1, wherein the reference constraints include one or more of: a minimum distance between the fork and a floor and a maximum tilt angle of the fork, and
wherein the operation parameters include one or more of: a height of the fork and a tilt angle of the fork.

3. The method of claim 1, the method further comprising:
picking up, by the fork, the pallet;
determining a geometry of the pallet; and
determining the new operation parameters further based on the geometry of the pallet.

4. The method of claim 3, wherein picking up, by the fork, the pallet comprises:
determining a first direction along which the fork extends;
determining a second direction along which the pallet extends; and
adjusting one or more of a height and a tilt of the fork to align the first direction with the second direction as the fork approaches the pallet.

5. The method of claim 3, the method further comprising:
adjusting the operation parameters to cause the pallet carried by the fork to maintain clearance from an overhead obstacle while transitioning between the first piecewise flat floor segment and the second piecewise flat floor segment.

6. The method of claim 1, the method further comprising:
determining that the autonomous mobile robot is transitioning from the second piecewise flat floor segment to a third piecewise flat floor segment;
determining that a third geometry of the third piecewise flat floor segment is unknown;
in response to determining that the third geometry of the third piecewise flat floor is unknown, activating one or more sensors; and
performing closed-loop monitoring by the autonomous mobile robot to adjust the operation parameters of the fork based on signals received from the one or more sensors.

7. The method of claim 1, the method further comprising:
receiving first sensor data from a first sensor at a first end of a fork and second sensor data from a second sensor at a second end of the fork;
determining a first distance from the first end of the fork to floor based on the first sensor data and a second distance from the second end of the fork to floor based on the second sensor data;
determining whether a difference between the first distance and the second distance is greater than a first threshold;
responsive to determining that the difference between the first distance and the second distance is greater than the first threshold, adjusting operation parameters based on the determined difference.

8. The method of claim 7, the method further comprising:
in response to determining that the difference between the first distance and the second distance is greater than a second threshold that is greater than the first threshold, issuing an alert or stopping the autonomous mobile robot to prevent collision or damage.

9. The method of claim 6, wherein the closed-loop monitoring includes:
determining a distance between the fork and a floor based on sensor data received from the one or more sensors; and
dynamically adjusting one or more of a tilt and a height of the fork to prevent the fork or a pallet being lifted by the fork from making contact with the floor.

10. The method of claim 1, wherein the autonomous mobile robot operates at any given time in a model-based mode or a closed-loop mode,
wherein in the model-based mode, the autonomous mobile robot navigates based on model data describing piecewise flat floor segments,
wherein in the closed-loop mode, the autonomous mobile robot navigates based on sensing data generated by the one or more sensors, and
wherein the autonomous mobile robot automatically switches between the model-based mode and the closed-loop mode in response to determinations as to whether model data of a piecewise flat floor segment is available.

11. The method of claim 10, the method further comprising:
determining that the autonomous mobile robot is transitioning from the second piecewise flat floor segment to a third piecewise flat floor segment;
determining a third geometry of the third piecewise flat floor segment based on sensing data generated by the one or more sensors in closed-loop mode;
determining a confidence level in an accuracy of the determined third geometry of the third piecewise flat floor segment; and
responsive to determining that the confidence level in the accuracy of the determined third geometry of the third piecewise flat floor segment is greater than a predetermined threshold, switching from the closed-loop mode to the model-based mode.

12. The method of claim 1, the method further comprising:
storing data of geometries encountered during transitions between the first piecewise flat floor segment and the second piecewise flat floor segment; and
preemptively adjusting the operation parameters based on the stored data in a next transition between the first piecewise flat floor segment and the second piecewise flat floor segment.

13. The method of claim 1, wherein determining that the second geometry would cause the operation parameters to no longer satisfy the reference constraints includes determining whether an angle change between the first piecewise flat floor segment and the second piecewise flat floor segment.

14. The method of claim 13, wherein adjusting a tilt and a height of the fork is based on the angle change.

15. The method of claim 1, wherein the one or more sensors include one or more of a light detection and ranging (LIDAR) sensor, stereo camera, 2D camera, 3D camera, ultrasound sensor, inertial measurement unit, global positioning system (GPS), and time-of-flight camera.

16. An autonomous mobile robot comprising:
a fork configured to carry a pallet, wherein the fork is set to operation parameters that satisfy reference constraints;
one or more sensors;
one or more processors; and
a non-transitory computer-readable medium storing instructions that, when executed by the processor, cause the processor to:
determine that an autonomous mobile robot, having a fork configured to carry a pallet, is transitioning from a first piecewise flat floor segment having a first geometry to a second piecewise flat floor segment having a second geometry based on sensing data generated by one or more sensors integrated with the autonomous mobile robot, wherein the fork is set to operation parameters that satisfy reference constraints;
determine that the second geometry would cause the operation parameters to no longer satisfy the reference constraints;
determine new operation parameters based on the second geometry that satisfy the reference constraints; and
transmit one or more control signals to the fork to transition to using the new operation parameters when the autonomous mobile robot enters the second piecewise flat floor segment.

17. The autonomous mobile robot of claim 16, wherein the reference constraints include one or more of a minimum distance between the fork and a floor and a maximum tilt angle of the fork, and
wherein the operation parameters include one or more of a height of the fork and a tilt angle of the fork.

18. The autonomous mobile robot of claim 16, wherein the one or more processors are further caused to:
pick up, by the fork, the pallet;
determine a geometry of the pallet; and
determine the new operation parameters further based on the geometry of the pallet.

19. The autonomous mobile robot of claim 18, wherein the one or more processors are further caused to:
determine a first direction along which the fork extends;
determine a second direction along which the pallet extends; and
adjust one or more of a height and a tilt of the fork to align the first direction with the second direction as the fork approaches the pallet.

20. The autonomous mobile robot of claim 16, wherein the one or more processors are further caused to:
determine that the autonomous mobile robot is transitioning from the second piecewise flat floor segment to a third piecewise flat floor segment;
determine that a third geometry of the third piecewise flat floor segment is unknown;
in response to determining that the third geometry of the third piecewise flat floor is unknown, activate one or more sensors; and
perform closed-loop monitoring by the autonomous mobile robot to adjust the operation parameters of the fork based on signals received from the one or more sensors.
